(19) United States
(12) Patent Application Publication
(10) Pub. No.: US 2007/0245325 A1
(43) Pub. Date: Oct. 18, 2007

(54) Type inference for optimized XSLT implementation

(75) Inventors: Anton V. Lapounov, Redmond, WA (US); Ralf Lammel, Redmond, WA (US); Sergey Dubinets, Bellevue, WA (US)

Correspondence Address: WOODCOCK WASHBURN LLP (MICROSOFT CORPORATION), CIRA CENTRE, 12TH FLOOR, 2929 ARCH STREET, PHILADELPHIA, PA, 19104-2891, US

(73) Assignee: Microsoft Corporation, Redmond, WA (US)

(21) Appl. No.: 11/521,140

(22) Filed: Sep. 13, 2006

Related U.S. Application Data
(60) Provisional application No. 60/789,554, filed on Apr. 4, 2006.
(60) Provisional application No. 60/789,555, filed on Apr. 4, 2006.

(51) Int. Cl. G06F 9/45

(52) U.S. Cl. 717/140

(57) ABSTRACT

Type inference techniques are provided for use in compiling an Extensible Markup Language Transforms (XSLT) stylesheet into a compiled XSLT processor. Using “variant” storages instead of an appropriate efficient representation is both memory-costly (requires more space) and computationally inefficient (requires runtime type switching during execution of the expression). Type inference may be used to determine what types may be assigned to variables and parameters during execution of an XSLT program.

### CROSS REFERENCE TO RELATED APPLICATIONS

This application claims priority to U.S. Provisional Application 60/789,554, filed Apr. 4, 2006. This application is related by subject matter to U.S. Provisional Application 60/789,555, filed Apr. 4, 2006, and any subsequent nonprovisional applications claiming priority thereto.

### BACKGROUND

XSL Transformations (XSLT) is a standard way to describe how to transform the structure of a first Extensible Markup Language (XML) document into a markup language document with a different structure. Extensible Stylesheet Language (XSL), XML, and XSLT are recommendations of the World Wide Web Consortium (W3C). There may be any number of versions of such recommendations, as with other electronics industry standards, and any versions are contemplated when such recommendations and standards are referenced herein. Specific versions are noted when helpful to the explanation.

Straightforward implementations of declarative languages are prohibitively inefficient. Dozens of XSLT processors are on the market, and they explore many different, non-trivial optimizations that aim to provide adequate execution performance and memory footprint.

Present optimization opportunities include: XPath expression normalization, XPath expression special casing, simple type inference, special casing of queries with singleton results, document-order preserving implementations that minimize or eliminate the need for sorting, efficient run-time representations of the input tree, symbolic representation of the templates as highly resolved expressions trees, output streaming, lazy evaluation, common subexpression elimination, compilation to byte code, and Just-In-Timing (JITing).

This field is still in flux. A consolidated opinion does not exist regarding the question whether the effort for a full-blown compiler is worth it, given the challenges of setting up a compiler architecture for XSLT. However, it increasingly appears the limits of non-compiling implementations are somewhat exhausted, and although compiler implementation requires major efforts, it may be an important next step in obtaining further gains.

Performance of XSLT processors is an important characteristic for XML users. The field is highly competitive, with each product achieving improvements and gains on a year-to-year basis. While there are a number of XSLT engines on the market that implement naïve type inference, for example, MSXML® and SAXON®, there are none but XslCompiledTransform produced by MICROSOFT® Corporation of Redmond, Wash. that implement full type inference for the types of XPath 1.0 and XSLT 1.0 in an efficient manner. Presently, XslCompiledTransform is arguably the fastest, standard-compliant implementation. It is included in .NET 2.0.

While type inference is a well-studied topic in computer science the problem of efficient and general type inference for XSLT programs has not been addressed. In “naïve” type inference, types are inferred locally, per template. Naïve type inference is limited as can be appreciated from a study of the XSLTMark suite. More general and efficient type inference for XSLT would be an important advance in the industry.

There is a related research effort on the subject of type checking stylesheets in terms of available DTDs or XML schemas including other static program analysis than just plain type checking. This work does not apply to the problem of type inference for untyped XSLT 1.0. The aforementioned work also does not provide efficient implementation of inference and the use of the inferred information in an optimizing compiler. There is another related research direction: the design of new languages that allow for type checking and type inference. Of course, this work is not applicable, by definition, to XSLT.

There is a related work on adding type checking or type inference to languages such as Smalltalk and Erlang. This work is not applicable to XSLT because of strict language dependence, or at least language class dependence, of such solutions. In particular, untyped languages other than XSLT 1.0 do not exhibit challenges like XPath expressions, set semantics (node sets), catch-all template calls, and others.

Finally, the normal tradition of strongly typed languages with type inference, started with work by Hindley and Milner is concerned with particular forms of polymorphism and the maintainability of type inference capability for such highly polymorphic and otherwise expressive, often functional, programming languages. This should be distinguished from efficient implementation of type inference for values such as simple types, node sets, singleton node sets, not including polymorphic data structures or functions, and not including structural types other then homogenous node sets, and the use of this information in the optimizing compilation of XSLT programs.

### SUMMARY

In consideration of the above-identified shortcomings of the art, the present invention provides systems, methods, and computer readable media for performing type inference when compiling an Extensible Markup Language Transforms (XSLT) stylesheet into a compiled XSLT processor.

In XPath/XSLT, expression evaluation occurs with respect to the dynamic context. One part of the dynamic context is a set of variable bindings. As related to XSLT, this set contains bindings of all global and local variables and parameters that are in-scope for a given XPath expression, and therefore, may be referenced from it using $<name> notation.

XSLT 1.0 is a type-less language, which means that any variable or parameter may be assigned a value of any type. There are four data types supported by XPath 1.0 and one additional type introduced by XSLT 1.0: node set, Boolean, number, string, and result tree fragment.

These data types are presented very differently in a computer. For example, a Boolean may be represented as a 4-byte integer number with values 0 and 1, a number may be represented as 8-byte IEEE 754 floating-point number, a string may be represented as a pointer to a character array residing in the heap memory, and a node set may be represented as a linked list of nodes. If the type of a value that will be assigned to a variable or a parameter is not known in advance, a “variant” data storage that can hold values of any type must be allocated for that variable or parameter. Using “variant” storages instead of an appropriate efficient representation is both memory-costly (requires more space) and computationally inefficient (requires runtime type switching during execution of the expression). The whole point of type inference is to determine what types may be assigned to variables and parameters during execution of an XSLT program. Thereby, type inference enables the more efficient execution of XSLT programs since the inferred type information can be used directly by a code generator in an XSLT compilation architecture to allocate appropriate data storages. As an aside, the exploitation of type inference is not limited to the use in a compilation architecture. For instance, one could also use this information in an interpreter, a JITer or other components that actually or symbolically execute XSLT programs.

Despite the fact that XSLT 1.0 is a type-less language and types of variables and parameters referring by an XPath 1.0 expression may not be known yet, the result types of XPath operators and XPath/XSLT functions are virtually always fixed. Aspects of our invention can exploit this fact, which leads to a very efficient non-iterative type inference implementation.

While naïve type inference on a per xsl:template basis may infer types for many local variables, making them strongly-typed, a more sophisticated inter-template analysis is preferable to infer types of local (template) parameters. However, performing such an analysis may provide significant performance improvement due to more efficient XSLT processing.

For example, the XSLTMark suite, which is a widely used XSLT processor performance benchmarking application, contains a queens.xsl stylesheet, which finds all the possible solutions to the problem of placing N queens on an N×N chess board without any queen attacking another. This stylesheet contains 20 local parameters. None of them may be strongly-typed using the type inference on a per xsl:template basis. Nevertheless, the inter-template analysis described below infers strong types for 16 of those 20 parameters, improving the execution time by several folds.

Another aspect of our type inference technique is that it enables general node sets and node sets containing exactly one node. While general node sets are usually represented as vectors of nodes or iterators, a node set containing exactly one node may be more efficiently represented by that node itself, thus eliminating extra memory allocations or function calls to iterator methods.

Other advantages and features of the invention are described below.

### BRIEF DESCRIPTION OF THE DRAWINGS

The systems and methods for type inference for optimized XSLT implementation in accordance with the present invention are further described with reference to the accompanying drawings in which:

FIG. 1 broadly illustrates various phases of an exemplary program analysis for XSLT programs that may be conducted to achieve type inference.

FIG. 2 illustrates an exemplary detailed embodiment for a “naïve” type inference phase.

FIG. 3 illustrates an exemplary detailed embodiment for building a data-flow graph.

FIG. 4 illustrates an exemplary detailed embodiment for propagation type flags through a data-flow graph.

FIG. 5 illustrates an exemplary detailed embodiment for allocating data storages according to computed type flags.

### DETAILED DESCRIPTION

Certain specific details are set forth in the following description and figures to provide a thorough understanding of various embodiments of the invention. Certain well-known details often associated with computing and software technology are not set forth in the following disclosure, however, to avoid unnecessarily obscuring the various embodiments of the invention. Further, those of ordinary skill in the relevant art will understand that they can practice other embodiments of the invention without one or more of the details described below. Finally, while various methods are described with reference to steps and sequences in the following disclosure, the description as such is for providing a clear implementation of embodiments of the invention, and the steps and sequences of steps should not be taken as required to practice this invention.

In one embodiment, contemplated systems and methods cam perform type inference in a system with a call-graph, a data-flow graph, various flow analyses and an optimizing code generator. The performance of a technology such as XslCompiledTransform is achieved through a combination of techniques including optimizations as referenced in the background section, as well as: computation of a call graph, computation of a data-flow graph, side-effect inference, type inference, as described herein, unused parameter elimination, dead-code elimination, and focus inference, as described in U.S. Provisional Application 60/789,555.

Example of Type Inference

Consider the following template:

```
<xsl:template name=“callee”>
  <xsl:param name=“par”/>
  <xsl:variable name=“var1” select=“count(foo)”/>
  <xsl:variable name=“var2” select=“.”/>
  <xsl:variable name=“var3”>
  <foo/>
  </xsl:variable>
  <xsl:variable name=“var4” select=“$par”/>
</xsl:template>
```

Independently of other templates containing in the stylesheet, we may infer that:
The type of $var1 is number.
The type of $var2 is node (e.g., single-node node set).
The type of $var3 is result tree fragment.

On the contrary, the types of $par and $var4 cannot be determined without analyzing all callers of the given template. For instance, if all callers pass string values for the “par” parameter, we may infer type string for both $par and $var4. If some callers pass string values, and others pass node set values, then we cannot make $par and $var4 strongly-typed, and may end up allocating “variant” storages for them.

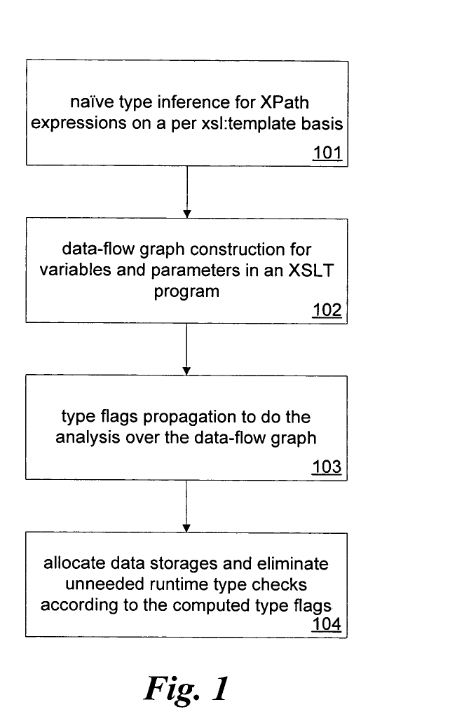

In one embodiment, type inference may be conducted using a program analysis for XSLT programs that comprises the phases illustrated in FIG. 1, each of which is described in greater detail below. The phases illustrated in FIG. 1 are: Naïve type inference for XPath expressions on a per xsl:template basis 101, Data-flow graph construction for all variables and parameters in an XSLT program 102, Type flags propagation to do the analysis over the data-flow graph 103, and Allocation data storages and eliminating unneeded runtime type checks according to the computed type flags 104.

While FIGS. 1-5 are presented as steps of exemplary methods, it should be understood that such steps may be implemented as components in a computing system and/or as instructions on computer readable medium.

Phase 1—Naïve Type Inference for XPath Expressions

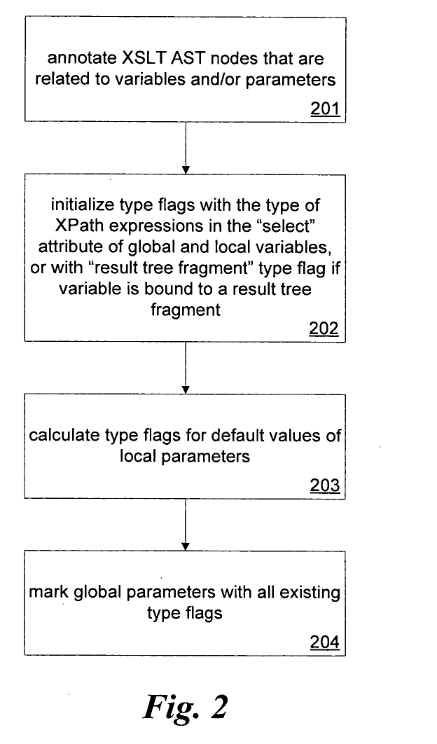

According to step 101 in FIG. 1, one embodiment may conduct a “naïve” type inference step. Exemplary embodiments of such a step 101 may proceed according the method illustrated in FIG. 2. Such a method may annotate XSLT Abstract Syntax Tree (AST) nodes related to variables and parameters with type flags for type inference 201. For example, these flags may carry the following names: XslFlags.String, XslFlags.Number, XslFlags.Boolean, XslFlags.Node, XslFlags.Nodeset, XslFlags.Rtf. These type flags record the types of values that may be assigned to a corresponding variable or parameter. The XslFlags.Rtf flag is used when the value is of type “result tree fragment”, specific for XSLT 1.0:

```
<xsl:variable name=“var”>
  <!-- XSLT code here -->
  ...
</xsl:variable>
```

Other flags denote the corresponding XPath data types, except for XslFlags.Node, which indicates a node set containing exactly one node.

Global and Local Variables

For every global or local variable, one embodiment of the invention may initialize its type flags with the type of the XPath expressions contained in the “select” attribute of that variable, or XslFlags.Rtf if the variable is bound to a result tree fragment 202. For the majority of XPath expressions their types may be inferred in a straight-forward manner using semantics of XPath operators and signatures of XPath and XSLT functions:

<!-- ‘+’ operation always yields number -->
<xsl:variable name=“var1” select=“$par + $par”/>
<!-- ‘concat’ function always yields string -->
<xsl:variable name=“var2” select=“concat($par, $par)”/>

However, if an expression contains just a variable reference ($<name>), its type cannot be inferred by a naïve type inference algorithm:

<!-- Type cannot be inferred by naive method -->
<xsl:variable name=“var3” select=“$par”/>

In this case type flags cannot be inferred without inter-template analysis, and are not set initially.

Local Parameters

Since values of local parameters are specified by callers, naïve type inference method cannot infer their type flags. In one embodiment, type flags may be calculated for default values of local parameters 203, without setting any type flags on local parameters themselves.

Global Parameters and Extension Functions

An XSLT stylesheet may have global parameters, whose values are to be specified at execution time, and therefore, not known during compilation of that stylesheet. Effectively, global parameters may be assigned values of arbitrary type, so they are marked with all existing type flags 204.

<!-- All data types are possible -->
<xsl:param name=“var4” select=“0”/>

In addition, the XslCompiledTransform engine allows a stylesheet to involve calls to extension functions, whose return types are not known at compile time either. In one embodiment, such calls are treated the same way as global parameters.

<!-- All data types are possible -->
<xsl:variable name=“var5” select=“user:ext(.)”/>

Phase 2—Data-Flow Graph Construction

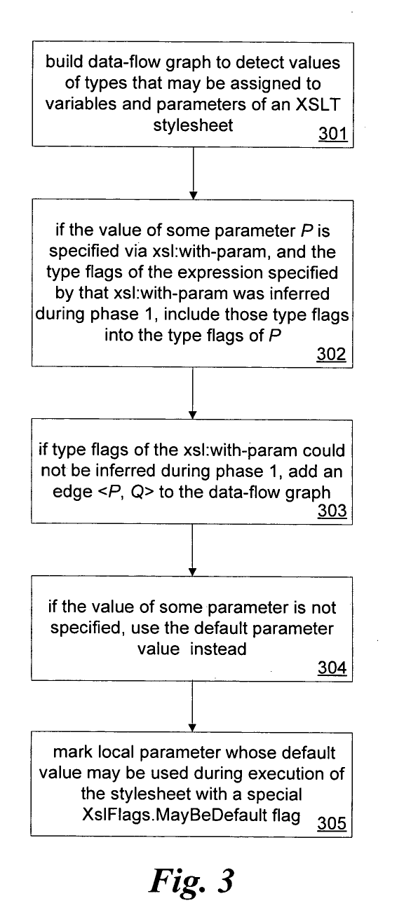

According to step 102 in FIG. 1, one embodiment may build a data flow graph. Exemplary embodiments of such a step 102 may proceed according the method illustrated in FIG. 3. Such an embodiment may conduct a data-flow analysis for inter-template type inference on the sample template “callee” with parameter “par”. This data-flow analysis can be automated as follows.

In one embodiment, the method may begin by building a data-flow graph to detect values of which types really may be assigned to variables and parameters of an XSLT stylesheet 301. In one exemplary algorithm, a data-flow graph represents the relation “can-be-assigned to” for three cases:
1. xsl:call-template
2. xsl:apply-templates
3. xsl:apply-imports

The first two of these instructions may specify values of callee's local parameters via its xsl:with-param children nodes. If the value of some parameter P is specified via xsl:with-param, and the type flags of the expression specified by that xsl:with-param was inferred during phase 1, those type flags are included into the type flags of P 302. Suppose that the type flags of the xsl:with-param could not be inferred during phase 1, which means it contains just a variable or a parameter reference:

<xsl:with-param name=“P” select=“$Q”/>

In this case we add an edge <P, Q> to the data-flow graph 303.

If the value of some parameter is not specified (and in case of xsl:apply-imports it is never specified), the default parameter value will be used instead 304. It is important to distinguish the case when the value of a local parameter is always specified by callers. In such a case, we do not have to update the type flags of that parameter with the type flags of its default value. That makes a big difference, because even if there is no default value specified in the stylesheet, the empty string default value is assumed by XSLT 1.0 rules. Consider the following two equivalent templates:

```
<xsl:template name=“foo”>
  <xsl:param name=“node”/>
  ...
</xsl:template>
<xsl:template name=“foo”>
  <xsl:param name=“node” select=“‘’”/>
  ...
</xsl:template>
```

Suppose that all callers pass a single node as a value of the “node” parameter. In that case we may ignore the default value and infer node type.

A local parameter, whose default value may be used during execution of the stylesheet, is marked with a special XslFlags.MayBeDefault flag 305.

Phase 3—Inter-Template Type Flags Propagation

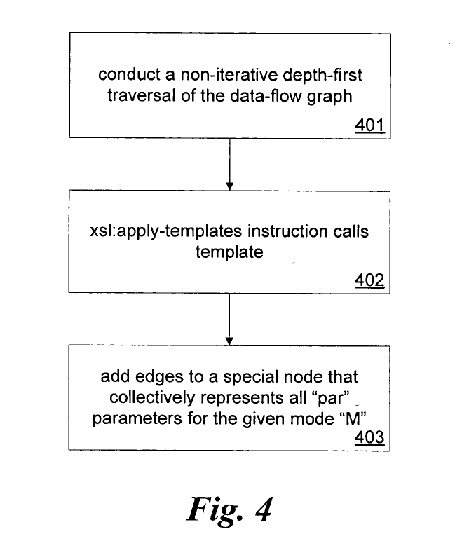

According to step 103 in FIG. 1, one embodiment may next conduct type flags propagation over the data-flow graph. Exemplary embodiments of such a step 103 may proceed according the method illustrated in FIG. 4. According to such an embodiment, given the existence of:
Type flags on variables and parameters per phase 1.
Data-flow graph per phase 2.
XslFlags.MayBeDefault flags on local parameters per phase 2.

Exemplary systems are now in the position to propagate type flags through the data-flow graph. In the general case of flow analysis the result is potentially obtained by means of a fix-point algorithm on a control-flow or data-flow graph (“stop if no more changes have been done in the previous pass”). It turns out type inference admits a more efficient approach: a one-pass (hence non-iterative) post-order (“depth-first”) traversal of the data-flow graph 401. This is an insight that contributes to the scalability of type inference.

Type Flags Propagation for xsl:apply-templates

In one embodiment, our technique handles the xsl:apply-templates instruction. Consider the following XSLT program:

```
<xsl:template name=“T1” match=“T1” mode=“M”>
  <xsl:param name=“par”/>
</xsl:template>
<xsl:template name=“T2” match=“T2” mode=“M”>
  <xsl:param name=“par”/>
</xsl:template>
<xsl:template name=“Tmain” match=“*” mode=“M”>
  <xsl:apply-templates>
    <xsl:with-param name=“par” select=“...”/>
  </xsl:apply-templates>
</xsl:template>
```

In this case, the xsl:apply-templates instruction may call either the “T1” template or the “T2” template according to step 402, and therefore the type flags of the both “par” parameters depend on the type flags of the XPath expression denoted by the ellipsis. This means that logically we should add as many edges to the data-flow graph as there are templates that have the “par” parameter and carry the relevant mode “M”. In one exemplary embodiment, we instead add edges to a special node that collectively represents all “par” parameters for the given mode “M” according to step 403. This also improves scalability of the inference. As an aside, this discussion also demonstrates that type inference naturally interacts with the XSLT concept of modes.

Phase 4—Allocation of Data Storages and Eliminating Type Checks

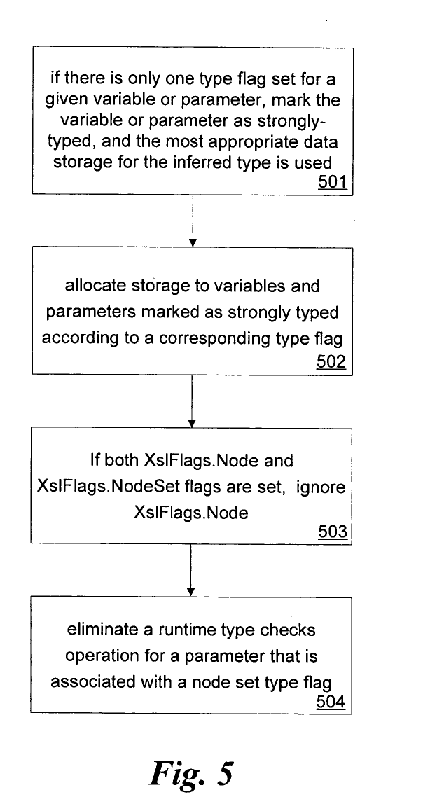

According to step 104 in FIG. 1, one embodiment may next allocate data storages and optionally also eliminate unneeded runtime checks. Exemplary embodiments of such a step 104 may proceed according the method illustrated in FIG. 5. According to such an embodiment, given the final type flags obtained as the result of phase 3, the optimal data storages can be allocated for all variables and parameters. If there is only one type flag set for a given variable or parameter, it is marked as strongly-typed 501, and the most appropriate data storage for the inferred type is used 502: System.Double for XslFlags.Number, System.String for XslFlags.String, and so on. If both XslFlags.Node and XslFlags.NodeSet flags are set, the former is ignored 503, since a single node is a particular case of a node set.

A number of other optimizations may be made based on the computed set of type flags. For example, predicates are valid on node set only, and, in general, one needs to check the runtime type of a parameter before applying the predicate to it. However, if the type node set has been inferred for the parameter, the runtime check is not needed, and may be optimized out 504:

```
<xsl:template name=“foo”>
  <!-- Flags XslFlags.Node and XslFlags.Nodeset inferred -->
  <xsl:param name=“par”/>
  <!-- No runtime type check generated -->
  <xsl:value-of select=“$par[1]”/>
</xsl:template>
```

As another example, the XslCompiledTransform engine uses the same data structure for representing both node and result tree fragment types. Thus, if the computed set of type flags contains only XslFlags.Node and XslFlags.Rtf flags, the data storage for the node type will be used, however, the code generator will insert runtime type checks for all operations that are valid on node sets, but invalid on result tree fragments:

```
<xsl:template name=“foo”>
  <!-- Flags XslFlags.Node and XslFlags.Rtf inferred -->
  <xsl:param name=“par”/>
  <!-- Runtime type check generated here -->
  <xsl:value-of select=“$par[1]”/>
</xsl:template>
```

Though we still need a runtime type check for the parameter “par”, we benefit from using the most efficient data storage for it.

Overview of Exemplary Implementation

This section presents an overview of an exemplary implementation. The logic, as described above, can be implemented in a system such as the .NET Framework 2.0. Such an implementation uses, for example, C# 2.0.

The exemplary implementation is located in the XslAstAnalyzer class, which is one of the internal classes of the XslCompiledTransform implementation. This class implements a visitor on the XSLT AST—the in-memory tree that represents stylesheets. We use the standard visitor pattern here. We refer to Listing 1 for the visitor methods which resemble the AST node types for an XSLT program.

The visitor traverses the AST in bottom-up manner while naïvely inferring type flags for variables and parameters according to phase 1 and adding edges to the data-flow graph according to phase 2. Hence, phase 1 and phase 2 are carried out in an interleaved manner. The visit methods also build data structures for other program analyses as mentioned earlier. Listing 2 demonstrates a sketch of the helper XPathAnalyzer class used for computing type flags for XPath expressions. If an XPath expression contains just a variable or parameter reference with optional parentheses, its type flags cannot be inferred naïvely, and in that case XPathAnalyzer returns the variable or the parameter that governs the type of the expression (“type donor”), so XslAstAnalyzer could use that information constructing the data-flow graph.

We refer to Listing 3 for a sketch of the graph class that is instantiated for data-flow graphs. Upon completion of the visitor's work, the XslAstAnalyzer class calls the PropagateFlag( ) method separately for each of the data type flags. The propagation method is also shown in Listing 3.

As a result of this analysis, all variables and parameters in the AST are annotated with XslFlags and the “code generator” component of the XSLT compiler can use this information directly to allocate the most appropriate data storages for them.

In addition to the specific implementations explicitly set forth herein, other aspects and implementations will be apparent to those skilled in the art from consideration of the specification disclosed herein. It is intended that the specification and illustrated implementations be considered as examples only, with a true scope and spirit of the following claims.

### Listing 1—The Visitor for XSLT Stylesheets

The shown methods correspond to the AST node types for XSLT programs.

```
protected override XslFlags Visit(XslNode node) { ... }
protected override XslFlags VisitChildren(XslNode node) { ... }
protected override XslFlags VisitAttributeSet(AttributeSet node) { ... }
protected override XslFlags VisitTemplate(Template node) { ... }
protected override XslFlags VisitApplyImports(XslNode node) { ... }
protected override XslFlags VisitApplyTemplates(XslNode node) { ... }
protected override XslFlags VisitAttribute(NodeCtor node) { ... }
protected override XslFlags VisitCallTemplate(XslNode node) { ... }
protected override XslFlags VisitComment(XslNode node) { ... }
protected override XslFlags VisitCopy(XslNode node) { ... }
protected override XslFlags VisitCopyOf(XslNode node) { ... }
protected override XslFlags VisitElement(NodeCtor node) { ... }
protected override XslFlags VisitError(XslNode node) { ... }
protected override XslFlags VisitForEach(XslNode node) { ... }
protected override XslFlags VisitIf(XslNode node) { ... }
protected override XslFlags VisitLiteralAttribute(XslNode node) { ... }
protected override XslFlags VisitLiteralElement(XslNode node) { ... }
protected override XslFlags VisitMessage(XslNode node) { ... }
protected override XslFlags VisitNumber(Number node) { ... }
protected override XslFlags VisitPI(XslNode node) { ... }
protected override XslFlags VisitSort(Sort node) { ... }
protected override XslFlags VisitText(Text node) { ... }
protected override XslFlags VisitUseAttributeSet(XslNode node) { ... }
protected override XslFlags VisitValueOf(XslNode node) { ... }
protected override XslFlags VisitValueOfDoe(XslNode node) { ... }
protected override XslFlags VisitParam(VarPar node) { ... }
protected override XslFlags VisitVariable(VarPar node) {
    node.Flags = ProcessVarPar(node);
    return node.Flags & ~XslFlags.TypeFilter;
}
protected override XslFlags VisitWithParam(VarPar node) {
    node.Flags = ProcessVarPar(node);
    return node.Flags & ~XslFlags.TypeFilter;
}
private XslFlags ProcessVarPar(VarPar node) {
    XslFlags result;
    if (node.Select != null) {
        result = xpathAnalyzer.Analyze(node.Select);
        typeDonor = xpathAnalyzer.TypeDonor;
        if (typeDonor != null && node.NodeType !=
        XslNodeType.WithParam) {
            dataFlow.AddEdge(typeDonor, node);
        }
    } else if (node.Content.Count != 0) {
        result = XslFlags.Rtf | VisitChildren(node);
        typeDonor = null;
    } else {
        result = XslFlags.String;
        typeDonor = null;
    }
    return result;
}
```

### Listing 2—XPath Expression Analyzer

This class is used to compute type flags of XPath expressions.

```
  internal class XPathAnalyzer : IXPathBuilder<XslFlags> {
    // If the expression is just a reference to some VarPar, like “(($foo))”,
    // then this property contains that VarPar, and null otherwise.
    public VarPar TypeDonor {
        get { return typeDonor; }
    }
    private static XslFlags[ ] OperatorType = {
```

| | |
|---|---|
| /*Or | */ XslFlags.Boolean, |
| /*And | */ XslFlags.Boolean, |
| /*Plus | */ XslFlags.Number , |
| /*Minus | */ XslFlags.Number , |
| /*UnaryMinus | */ XslFlags.Number , |
| /*Union | */ XslFlags.Nodeset, |

```
      ... elided ...
    };
    public virtual XslFlags Operator(XPathOperator op, XslFlags left,
XslFlags right) {
        typeDonor = null;
        XslFlags result = (left | right) & ~XslFlags.TypeFilter;
        return result | OperatorType[(int)op];
    }
    private static XslFlags[ ] XPathFunctionFlags = {
```

| | |
|---|---|
| /*Not | */ XslFlags.Boolean, |
| /*Id | */ XslFlags.Nodeset \| XslFlags.Current, |
| /*Concat | */ XslFlags.String, |
| /*StartsWith | */ XslFlags.Boolean, |

```
      ... elided ...
    };
    private static XslFlags[ ] XsltFunctionFlags = {
```

| | |
|---|---|
| /*Document | */ XslFlags.Nodeset, |
| /*Key | */ XslFlags.Nodeset \| XslFlags.Current, |
| /*GenerateId | */ XslFlags.String, // \| XslFlags.Current |
| | if 0 args |

```
      ... elided ...
    };
    ... elided ...
  };
```

### Listing 3—General Graph Using Hashtable of Adjacency Lists

This class is used to represent (reverse) call graphs.

There is a general facility for flag annotation.

There is also readily support for propagation of flags (using DepthFirstSearch; elided).

```
internal class Graph<V> : Dictionary<V, List<V>>
    where V : XslNode
{
    private static IList<V> empty;
    public IEnumerable<V> GetAdjList(V v) { ... }
    public void AddEdge(V v1, V v2) { ... }
    public void PropagateFlag(XslFlags flag) {
        // Clean Stop flags
        foreach (V v in Keys) {
            v.Flags &= ~XslFlags.Stop;
        }
        foreach (V v in Keys) {
            if ((v.Flags & XslFlags.Stop) == 0) {
                if ((v.Flags & flag) != 0) {
                    DepthFirstSearch(v, flag);
                }
            }
        }
    }
    private void DepthFirstSearch(V v, XslFlags flag) { ... }
}
```

1. A method for performing type inference when compiling an Extensible Markup Language Transforms (XSLT) stylesheet into a compiled XSLT processor, comprising:
generating an Abstract Syntax Tree (AST) from said XSLT stylesheet;
annotating nodes in said AST that are associated with variables and parameters, wherein said annotating comprises associating said nodes with type flags, wherein said type flags record a type of value that may be assigned to said variables and parameters;
building a data-flow graph to detect a type of value of that may be assigned to said variables and parameters;
propagating any type flags through the data-flow graph;
marking variables and parameters as strongly typed if associated with only one type flag;
allocating storage to variables and parameters marked as strongly typed according to a corresponding type flag.

2. The method of claim 1, further comprising annotating a local parameter whose default value may be used during execution of said compiled XSLT processor with a “may be default” type flag.

3. The method of claim 1, wherein said type flags comprise a string type flag, a number type flag, a node set type flag, and a Boolean type flag.

4. The method of claim 1, wherein said type flags comprise a node type flag which indicates a node set containing exactly one node.

5. The method of claim 1, wherein said type flags comprise a result tree fragment type flag.

6. The method of claim 1, wherein said data-flow graph represents a can-be-assigned-to relation for an xsl:call-template case, an xsl:apply-templates case, and an xsl:apply-imports case.

7. The method of claim 1, further comprising eliminating a runtime type checks operation for a parameter that is associated with a node set type flag.

8. A system for performing type inference when compiling an Extensible Markup Language Transforms (XSLT) stylesheet into a compiled XSLT processor, comprising:
a component for generating an Abstract Syntax Tree (AST) from said XSLT stylesheet;
a component for annotating nodes in said AST that are associated with variables and parameters, wherein said annotating comprises associating said nodes with type flags, wherein said type flags record a type of value that may be assigned to said variables and parameters;
a component for building a data-flow graph to detect a type of value of that may be assigned to said variables and parameters;
a component for propagating any type flags through the data-flow graph;
a component for marking variables and parameters as strongly typed if associated with only one type flag;
a component for allocating storage to variables and parameters marked as strongly typed according to a corresponding type flag.

9. The system of claim 8, further comprising a component for annotating a local parameter whose default value may be used during execution of said compiled XSLT processor with a “may be default” type flag.

10. The system of claim 8, wherein said type flags comprise a string type flag, a number type flag, a node set type flag, and a Boolean type flag.

11. The system of claim 8, wherein said type flags comprise a node type flag which indicates a node set containing exactly one node.

12. The system of claim 8, wherein said type flags comprise a result tree fragment type flag.

13. The system of claim 8, wherein said data-flow graph represents a can-be-assigned-to relation for an xsl:call-template case, an xsl:apply-templates case, and an xsl:apply-imports case.

14. The system of claim 8, further comprising a component for eliminating a runtime type checks operation for a parameter that is associated with a node set type flag.

15. A computer readable medium bearing instructions for performing type inference when compiling an Extensible Markup Language Transforms (XSLT) stylesheet into a compiled XSLT processor, said instructions comprising:
instructions for generating an Abstract Syntax Tree (AST) from said XSLT stylesheet;
instructions for annotating nodes in said AST that are associated with variables and parameters, wherein said annotating comprises associating said nodes with type flags, wherein said type flags record a type of value that may be assigned to said variables and parameters;
instructions for building a data-flow graph to detect a type of value of that may be assigned to said variables and parameters;
instructions for propagating any type flags through the data-flow graph;
instructions for marking variables and parameters as strongly typed if associated with only one type flag;
instructions for allocating storage to variables and parameters marked as strongly typed according to a corresponding type flag.

16. The computer readable medium of claim 15, further comprising instructions for annotating a local parameter whose default value may be used during execution of said compiled XSLT processor with a “may be default” type flag.

17. The computer readable medium of claim 15, wherein said type flags comprise a string type flag, a number type flag, a node set type flag, and a Boolean type flag.

18. The computer readable medium of claim 15, wherein said type flags comprise a node type flag which indicates a node set containing exactly one node.

19. The computer readable medium of claim 15, wherein said type flags comprise a result tree fragment type flag.

20. The computer readable medium of claim 15, wherein said data-flow graph represents a can-be-assigned-to relation for an xsl:call-template case, an xsl:apply-templates case, and an xsl:apply-imports case.
